(19) United States
(12) Patent Application Publication
(10) Pub. No.: US 2020/0180353 A1
(43) Pub. Date: Jun. 11, 2020

(54) SHAPED TRANSFER ARTICLE COMPRISING PARTIALLY EMBEDDED MICROSPHERES, SHAPED FINISHED ARTICLES THEREFROM, AND METHODS OF MAKING

(71) Applicant: 3M INNOVATIVE PROPERTIES COMPANY, St. Paul, MN (US)

(72) Inventors: John C. Clark, Maplewood, MN (US); John P. Baetzold, North St. Paul, MN (US); Alexander J. Kugel, Woodbury, MN (US); Chris A. Pommer, Woodbury, MN (US)

(21) Appl. No.: 16/637,795

(22) PCT Filed: Aug. 29, 2018
(86) PCT No.: PCT/US2018/048516

§ 371 Date: Feb. 10, 2020

Related U.S. Application Data
(60) Provisional application No. 62/552,465, filed on Aug. 31, 2017.

(51) Int. Cl. B44C 1/17; B44C 5/04; B29C 39/12

(52) U.S. Cl. CPC B44C 1/1716; B44C 5/0453; B29K 2063/00; B44C 5/0476; B29C 39/123

(57) ABSTRACT

Described herein are shaped articles comprising a monolayer of microspheres partially embedded in its surface. The shaped articles are made via a transfer article (20), which comprises a microsphere monolayer (22) comprising a plurality of microspheres partially embedded in a first major surface of a transfer polymer layer (23), which is disposed on a support layer (21). The transfer article is shaped and a conformable substrate is contacted with the shaped transfer article, transferring the microspheres to the conformable substrate forming a shaped finished article having a surface comprising a monolayer of partially embedded microspheres.

### TECHNICAL FIELD

A shaped transfer article comprising a monolayer of partially embedded microspheres is described. Such shaped transfer articles can be used to form shaped finished goods, wherein the microspheres are transferred from the transfer article to surface of the finished good to impart desired surface properties to the finished good. Methods of making the shaped transfer article and the shaped finished article are also described.

### DESCRIPTION OF THE FIGURES

FIG. 1 depicts a process in the prior art for making a shaped finished good having a surface comprising partially embedded microspheres, where FIG. 1A is a cross-sectional view of a transfer carrier, FIG. 1B is a cross-sectional view of a transfer carrier and a bead bonding layer, FIG. 1C is a cross-sectional view of a free-standing bead film, FIG. 1D is a cross-sectional view of a laminate comprising the bead film and a substrate, and FIG. 1E is a cross-sectional view of a shaped finished good;

FIG. 2 depicts a process of the present disclosure for making a shaped finished good having a surface comprising partially embedded microspheres, where FIG. 2A is cross-sectional view of a shaped transfer article, FIG. 2B is a cross-sectional view of a shaped transfer article and a conformable substrate layer, and FIG. 2C is a cross-sectional view of an exemplary shaped finished article of the present disclosure;

FIG. 3 is a cross-sectional view of an exemplary shaped finished article of the present disclosure; and

FIG. 4 is a schematic of a mold used in the Example 1.

### SUMMARY

There is a need for a shaped article comprising a monolayer of microspheres at its surface.

In one aspect, a shaped transfer article is provided. The shaped transfer article comprises:
a microsphere monolayer comprising a plurality of microspheres;
a transfer polymer layer comprising a first major surface and an opposing second major surface; and
a support layer, wherein the plurality of microspheres is partially embedded in the first major surface of the transfer polymer layer; and the support layer is disposed on the second major surface of the transfer polymer layer; and
wherein the shaped transfer article is non-planar

In another aspect, a method of making a shaped article is provided. The method comprising:
obtaining a shaped transfer article comprising a plurality of microspheres partially embedded in its surface; and contacting the plurality of microspheres with a conformable substrate.

In yet another aspect, a shaped finished article is described comprising: a microsphere monolayer comprising a plurality of microspheres, wherein the plurality of microspheres is partially embedded in a composite, wherein the shaped finished article is not planar, and wherein the difference in the apexes of the plurality of microspheres deviates from the average by no more than 5 microns.

In still another embodiment, a shaped finished article is described comprising: a microsphere monolayer comprising a plurality of microspheres, wherein the plurality of microspheres is partially embedded in an epoxy, wherein the shaped finished article is not planar, and wherein the difference in the apexes of the plurality of microspheres deviates from the average by no more than 5 microns.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term
“a”, “an”, and “the” encompass embodiments having plural referents, unless the content clearly dictates otherwise; and
“and/or” is used to indicate one or both stated cases may occur, for example A and/or B includes, (A and B) and (A or B).

The prefix “(meth)” in front of for example, (meth)acrylic or (meth)acrylate refers to compounds containing the methylated form or the non-methylated. For example, (meth)acrylate refers to either an acrylate (CH₂═CHCOOR) or a methacrylate (CH₂═CCH3COOR) structure or combinations thereof.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

Microspheres, typically glass beads, have been incorporated into the surface of finished goods to improve the surface properties, for example, resistance to weather, chemicals, abrasion, etc., to impart ornamental effects, and/or to change the visual properties of the article.

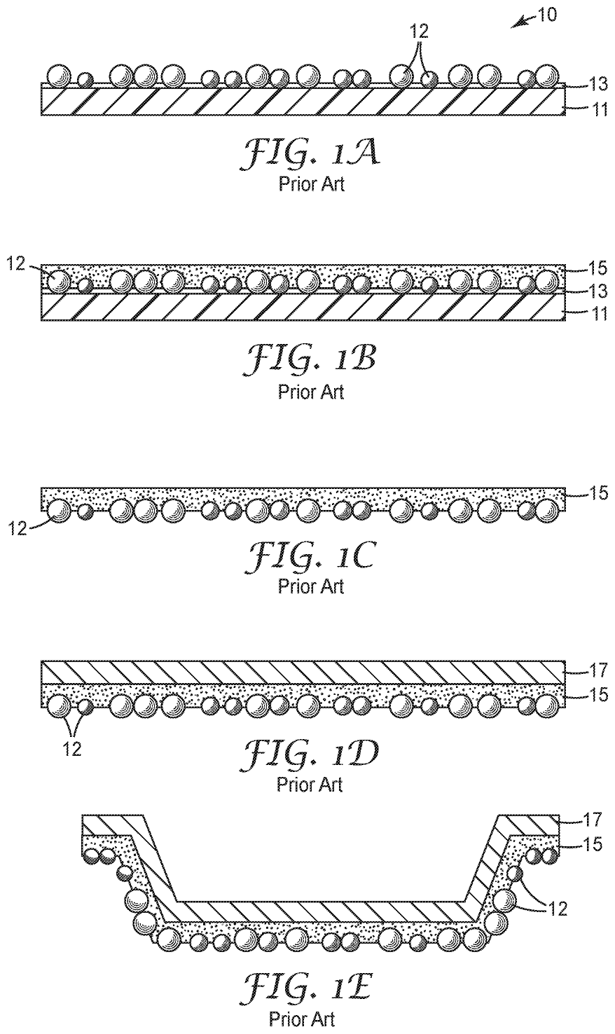

U.S. Pat. No. 9,650,499 (Walker et al.) discloses making thermoformable microsphere embedded articles via a transfer method as depicted in FIG. 1. The transfer method employs a transfer carrier shown in FIG. 1A, which in its simplest form comprises an optional support layer (e.g., a backing) 11 and transfer polymer layer 13 bonded thereto. A plurality of microspheres 12 is partially embedded in the transfer polymer layer to form transfer article 10. This transfer article is then contacted with a bead bonding layer 15 as shown in FIG. 1B. The transfer carrier comprising the transfer polymer layer and optional support layer are removed, leaving the plurality of microspheres partially embedded in the bead bonding layer as shown in FIG. 1C. Walker et al. teaches applying the free-standing bead films comprising the plurality of microspheres 12 partially embedded in bead bonding layer 15, onto substrate 17 (as shown in FIG. 1D) and then thermoforming the article of FIG. 1D into a shaped finished good as shown in FIG. 1E.

It has been discovered that instead of shaping the substrate comprising the bead film thereon, the transfer article can first be shaped into a mold negative and subsequently used to make the shaped finished article. Such a process enables a wider range of substrates to be used (i.e., not just thermoformable substrates or thermoformable bead bonding layers), can minimize process steps, and/or can enable improved properties of the shaped finished article of the prior art (e.g., eliminate delamination of the bead bond layer of the beaded film from the substrate since the microspheres are directly held in the substrate).

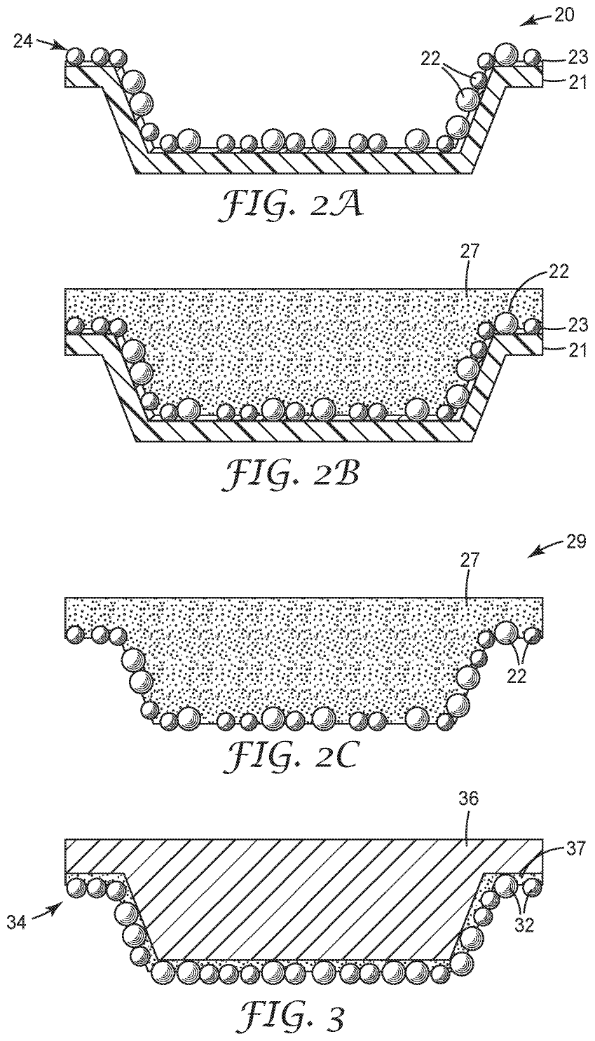

The process of the present disclosure is shown schematically in FIG. 2. First, shaped transfer article 20 is provided as shown in FIG. 2A. Shaped transfer article 20 comprises a microsphere monolayer 22, which are partially embedded in transfer polymer layer 23, which is disposed on support layer 21. After providing a shaped transfer article, conformable substrate 27 is contacted to the shaped transfer article and solidified as shown in FIG. 2B. The transfer carrier, comprising transfer polymer layer 23 and support layer 21, then is removed resulting in finished article 29, comprising a microsphere monolayer 22 wherein the plurality of microspheres is partially embedded in substrate 27 as shown in FIG. 2C.

As used herein, the term “shaped” refers to a first major surface of an object that is non-planar, for example, having at least a 1, 3, 5 or even 10 degree angle from a plane. In some embodiments, the first major surface of the shaped transfer articles and/or shaped finished articles of the present disclosure comprise a planar region, however, the major surface of the article comprises at least one portion, which deviates from a plane. In some embodiments, the shaped articles of the present disclosure are a three-dimensional shape such as a hemisphere, rectangle, cube, and polyhedron. In some embodiments, the corners or edges of the shaped article can have sharp angles, such as 90 degree angles or more acute angles. In some embodiments, the shaped articles have more gradual contours, such as, for example, sloped or curved edges.

### Shaped Transfer Article

An exemplary shaped transfer article of the present disclosure is depicted in FIG. 2A, which comprises a microsphere monolayer 22, wherein a plurality of microspheres is partially embedded in a first major surface of transfer polymer layer 23. The opposing second major surface of transfer polymer layer 23 is disposed on support layer 21.

### Microsphere Layer

The microsphere layer comprises a plurality of microspheres. The microspheres useful in the present disclosure comprise glass, glass ceramics, ceramics, polymers, metals, and combinations thereof. Glass is an amorphous material, while ceramic refers to a crystalline or partially crystalline material. Glass ceramics have an amorphous phase and one or more crystalline phases. These materials are known in the art.

In some embodiments, the microspheres are glass beads. The glass beads are largely spherically shaped. The glass beads are typically made by grinding ordinary soda-lime glass or borosilicate glass, typically from recycled sources such as from glazing and/or glassware. Common industrial glasses could be of varying refractive indices depending on their composition. Soda lime silicates and borosilicates are some of the common types of glasses. Borosilicate glasses typically contain boria and silica along with other elemental oxides such as alkali metal oxides, alumina etc. Some glasses used in the industry that contain boria and silica among other oxides include E glass, and glass available under the trade designation “NEXTERION GLASS D” from Schott Industries, Kansas City, Mo., and glass available under the trade designation “PYREX” from Corning Incorporated, New York, N.Y.

The grinding process yields a wide distribution of glass particle sizes. The glass particles are spherodized by treating in a heated column to melt the glass into spherical droplets, which are subsequently cooled. Not all the particles are perfect spheres. Some are oblate, some are melted together and some contain small bubbles. The microspheres of the present disclosure are not glass bubbles, in other words, if the microsphere does contain a bubble, the actual bulk density of the plurality of microspheres is within 10%, 5%, or even 1% of the theoretical density of the microspheres assuming a solid core (i.e., no bubbles).

In one embodiment, the microspheres are plastic particles. The plastic particles selected should comprise a hardness greater than the substrate surface to protect the underlying substrate surface. One exemplary plastic particle includes polyurethane, polystyrene, acrylic and methacrylic acid ester polymers and copolymers (e.g., poly(methyl methacrylate)), and polyurea spheres.

In one embodiment, the microspheres are metal particles comprising for example, aluminum, copper, tin, nickel, chrome, magnesium, titanium, iron, metal alloys (e.g., stainless steel and tungsten carbide), and combinations thereof.

The microspheres for use in the present invention are substantially spherical, for example, having a sphericity of at least 80%, 85%, or even 90%, where sphericity is defined as the surface area of a sphere (with the same volume as the given particle) divided by the surface area of the particle, reported as a percentage.

As a method for shaping inorganic particles into spherical ones, it is possible to apply a method in which the above-described inorganic material in an indeterminate form is ground, and melted in a high-temperature oven at a temperature above the melting point thereof, thereby obtaining spherical particles by utilizing the surface tension; or a method in which the above-described inorganic material is melted at a high temperature above the melting point thereof, and the melt is sprayed to obtain spherical particles.

In one embodiment, the microspheres of the present disclosure have a Knoop hardness of at least 1,300 kg/mm2, or even 1,800 kg/mm2 (kilograms/millimeter2). The “Knoop hardness” as used herein is an indentation of microhardness measured by using a Knoop indenter; it is a value obtained by dividing the applied load with which a rhombic indentation is formed on the surface of a sample, by the projected area of the indentation computed from the long diagonal of the permanent indentation. The method for measuring the Knoop hardness is described in ASTM C849-88 (2011) “Standard Test Method for Knoop Indentation Hardness of Ceramic Whitewares”.

The microspheres useful in the present disclosure may be transparent, translucent, or opaque.

In one embodiment, the microspheres have a refractive index of at least 1.4, 1.6, 1.8, 2.0 or even 2.2. The refractive index may be determined by the standard Becke line method.

The microspheres are preferably free of defects. As used herein, the phrase “free of defects” means that the microspheres have low amounts of bubbles, low amounts of irregular shaped particles, low surface roughness, low amount of inhomogeneities, low amounts of undesirable color or tint, or low amounts of other scattering centers, wherein low amount means less than 5% of the defects are present.

In some embodiments, a useful range of average microsphere diameters is at least 5, 10, 20, 25, 40, 50, 75, 100, or even 150 μm (micrometers); at most 200, 400, 500, 600, 800, 900, or even 1000 μm. The microspheres may have a unimodal or multi-modal (e.g., a bimodal) size distribution depending on the application.

The microspheres are typically sized via screen sieves or a cyclone separator to provide a useful distribution of particle sizes. Sieving is also used to characterize the size of the microspheres. With sieving, a series of screens with controlled sized openings is used and the microspheres passing through the openings are assumed to be equal to or smaller than that opening size. For microspheres, this is true because the cross-sectional diameter of the microsphere is almost always the same no matter how it is oriented to a screen opening.

In some embodiments, to calculate the “average diameter” of a mixture of microspheres one would sieve a given weight of particles such as, for example, a 100 gram sample through a stack of standard sieves. The uppermost sieve would have the largest rated opening and the lowest sieve would have the smallest rated opening.

Alternately, average diameter can be determined using any commonly known microscopic methods for sizing particles. For example, optical microscopy or scanning electron microscopy, and the like, can be used in combination with any image analysis software. For example, software commercially available as free ware under the trade designation “IMAGE J” from NIH, Bethesda, Md.

In one embodiment, the plurality of microspheres has a difference in size distribution of not more than 40% (30% or even 20%) based on the average microsphere diameter, meaning, that the largest diameter particle and the smallest diameter particle deviate from the average by no more than 40% (30% or even 20%).

In the present disclosure when making a shaped finished article, upon transfer, the transfer polymer layer releases the plurality of microspheres while the conformable substrate layer retains the plurality of microspheres. In one embodiment, the microspheres comprise a surface modification as is known in the art to improve the adhesion of the microspheres to the conformable substrate layer. Such treatments include those selected from the group consisting of silane coupling agent, titanate, organo-chromium complex, and the like, to maximize the adhesion of the microspheres to the conformable substrate layer. Preferably, the coupling agent is a silane such as aminosilane, glycidoxysilane, or acrylsilane.

In one embodiment, the treatment level for such coupling agents is on the order of 50 to 700 parts by weight coupling agent per million parts by weight microspheres. Microspheres having smaller diameters would typically be treated at higher levels because of their higher surface area. Treatment is typically accomplished by spray drying or wet mixing a dilute solution such as an alcohol solution (such as ethyl or isopropyl alcohol, for example) of the coupling agent with the microsphere, followed by drying in a tumbler or auger-fed dryer to prevent the microspheres from sticking together. One skilled in the art would be able to determine how to best treat the microspheres with the coupling agent.

### Transfer Polymer Layer

The transfer polymer should be selected such that it can (a) undergo shaping (e.g., thermoforming), (b) prevent or minimize the plurality of microspheres from substantially moving during shaping, (c) prevent or minimize the plurality of microspheres from substantially moving during the contacting of the microsphere monolayer with the conformable substrate, and (d) the plurality of microspheres will be released from the transfer polymer layer upon removal, leaving the plurality of microspheres partially embedded in the conformable substrate layer. Not substantially moving the plurality of microspheres means that the plurality of microspheres is maintained as a desired monolayer.

Useful materials for forming the transfer polymer layer include, but are not limited to, thermoplastics such as those selected from the group consisting of polyolefins such as polyethylene, and polypropylene; organic waxes; polyvinyl alcohol; polyvinyl acetate; ethylene vinyl acetate; blends thereof, and the like

In some embodiments, the transfer polymer layer can be solvent soluble, enabling dissolution of the transfer polymer layer from the shaped finished article upon contact with a solvent such as water, alcohol, heptane, etc.

In one embodiment, the transfer polymer layer comprises a low to medium density (about 0.910 to 0.940 g/cc density) polyethylene. A low to medium density polyethylene may be advantageous in the transfer polymer layer because it has a high enough melting point such that maintains its integrity (and the placement of the microspheres) while being exposed to a molten conformable material and/or during the heating involved with solidifying the conformable substrate. Furthermore, polyethylene releases from a range of materials which may be used as the conformable substrate layer as well as the microspheres.

In one embodiment, the transfer polymer layer comprises polypropylene. Polypropylene may be advantageous in applications that involve a higher temperature during the shaping of the transfer polymer layer and/or the processing temperature of the conformable material when it contacts the shaped transfer article.

In one embodiment, the transfer polymer layer is not tacky at ambient conditions. In one embodiment, the transfer polymer layer is not a pressure sensitive adhesive, meaning that the transfer polymer layer does not meet the Dahlquist criterion for tack in other words, the storage modulus (G′) measured at 1 rad/s is more than 3×105 Pascals.

The transfer polymer layer of the present disclosure can, upon application of heat and/or pressure, become tacky, enabling the movement of the plurality of microspheres into the transfer polymer layer. Preferably, after embedment of the microspheres, the transfer polymer layer is no longer tacky. The transfer polymer layer may regain tackiness during shaping, but the transfer polymer layer must retain enough mechanical integrity during shaping to hold the microspheres in place.

The microspheres may be partially embedded, for example, by applying a layer of microspheres on the transfer polymer layer followed by one of (1)-(3):(1) heating the transfer carrier, (2) applying pressure to the plurality of microspheres on the transfer carrier (with, for example, a roller) or (3) heating and applying pressure to the plurality of microspheres on the transfer carrier.

For a given transfer polymer layer, the microsphere embedment process is controlled primarily by temperature, time of heating, and thickness of the transfer polymer layer.

The thickness of the transfer polymer layer should be chosen to prevent encapsulation of most of the smaller diameter microspheres so that they will not be pulled away from the conformable substrate layer when the transfer polymer layer is removed. On the other hand, the transfer polymer layer must be thick enough so that the larger microspheres in the microsphere layer are sufficiently embedded to prevent their loss during subsequent processing operations.

The plurality of microspheres is embedded in the transfer polymer layer such the microspheres are sunk to at least 0.10, or even 0.20 times the diameter of the microsphere; and less than 0.30, 0.40, or even 0.50 times the diameter of the microsphere. In one embodiment, the nadir (i.e., lowest sunken point) of the microspheres are embedded to the same distance from the second major surface of the transfer polymer layer.

In one embodiment, the transfer polymer layer thickness is at least 0.1, or even 0.2 times the average diameter of the microspheres; and less than 0.30, 0.40, or even 0.50 times the average diameter of the microspheres. In one embodiment, the thickness of the transfer polymer layer is at least 5, 10, 15, 20, or even 25 micrometers; and at most 30, 50, 75, or even 100 micrometers. In one embodiment, the interface of the transfer polymer layer with the support layer becomes an embedment bonding surface enabling the microspheres to sink to a desired level as shown in FIG. 2A wherein the plurality of microspheres are sunk such that their nadir are at or in close proximity to the support layer 21. Alternatively, in another embodiment, there is a defined distance between the nadir of the plurality of microspheres and second major surface of the transfer polymer layer.

According to the present disclosure, the microsphere embedment in the finished article becomes approximately the mirror image of the transfer polymer layer embedment. For example, a microsphere which is embedded to about 30% of its diameter in the transfer polymer layer is typically embedded to about 70% of its diameter in surface of the conformable substrate.

### Support Layer

The transfer polymer layer may be disposed on a support layer, which is used to support the transfer polymer layer and the microspheres. The support layer should be “dimensionally stable”. In other words, it should not shrink, expand, phase change, etc. during the preparation of the transfer article. Useful support layers may be thermoplastic. One skilled in the art would be able to select a useful film for the support layer of the present disclosure. If the support layer is a thermoplastic film it should preferably have a melting point above that of the transfer polymer. Useful temporary support layers for forming the carrier include, but are not limited to those selected from the group consisting of polymeric films such as biaxially oriented polyethylene terephthalate (PET), polypropylene, polymethylpentene and the like which exhibit good temperature stability and tensile properties so they can undergo shaping.

The transfer article is shaped to form a negative (or opposite image) of the desired finished good. In one embodiment, a transfer article is shaped to form the shaped transfer article. In another embodiment, the transfer carrier comprising the transfer polymer layer and support layer, is shaped and then the plurality of microspheres is added to the first major surface of the transfer polymer layer to form a shaped transfer article. Such shaping of the transfer carrier with or without the plurality of microspheres may be performed using techniques known in the art, for example, thermoforming, vacuum forming, pressure forming, hydroforming or compression forming.

As used herein, the first major surface of the transfer article, shown as surface 24 in FIG. 2A, refers to the surface of the article which comprises the exposed microspheres and any transfer polymer located on the surface between the microspheres. It is this first major surface, which is contacted with the conformable substrate and the microsphere monolayer is transferred to the conformable substrate, resulting in a shaped finished article having desirable surface properties such as abrasion resistance and/or desirable tactile feel. If a planar portion of the first major surface of the shaped transfer article was tested for surface roughness, the surface may be rough, which would not be ideal for a desirable tactile interaction. Further, if the scratch resistance of the shaped transfer article were tested, it may have a scratch resistance of less than 1 H, which also would not be ideal for a finished article.

Surface roughness of an article may be described by analyzing the surface of the article using profilometry, wherein a stylus is traversed across the surface of the article monitoring the surface topography and the data analyzed to describe various parameters of the surface. For example, in one embodiment, the transfer article of the present disclosure has an Rq Envelope of greater than 3, 4, or even 5 micrometers and an Rp Envelope of greater than 7, 8, or even 10 micrometers. See the method at the end of the specification for more details about obtaining Rq and Rp Envelope.

### Conformable Substrate

In the present disclosure, the first major surface of the shaped transfer article is contacted with a conformable substrate. As used herein, a conformable substrate refers to a material, which will conform to the first major surface of the shaped transfer article and upon cooling or crosslinking will increase in viscosity.

Conformable materials can include flowable materials (such as liquids), which can be deposited onto the shaped transfer article. Conformable materials can also include films, which can be positioned onto the shaped transfer article and heat and/or pressure (positive or negative) can be applied to conform the substrate to the first major surface of the shaped transfer article.

The conformable material may be identified as a thermoset or a thermoplastic. As used herein a thermoset is a material, which undergoes a chemical reaction resulting in a product which is chemically different from the starting materials and upon solidification may not be remelted. The chemical reaction can be a result of reactive chemical functionality of the resins or applied ionizing radiation capable of causing irreversible chemical crosslinks. A thermoplastic is a material which may solidify, but is not chemically different from the starting material and can be remelted upon application of heat and/or pressure.

Exemplary thermosets include those made from benzoxazine resins; bis-maleimides; cyanate ester resins; epoxy resins; phenolic resins; unsaturated polyester resins; polyimides; isocyanate and polyisocyanate resins; polyisocyanurate resins; silicone resins such as those cured via a peroxide, thermal or moisture curing mechanism; vinyl ester resins; styrenic and styrenic adduct resins; meth(acrylic) resins; alkyd resins; amino resins; urea-formaldehyde resins; melamine-formaldehyde resins; furan resins; saturated and unsaturated rubbers such as ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, polyisoprene, polyisobutylene, polybutadiene, polychloroprene, butyl rubber, halogenated butyl rubbers, styrene-butadiene rubber, nitrile rubber, hydrogenated nitrile rubbers which can be crosslinked with sulfur, peroxides, metallic oxides, acetoxysilane, or isocyanate; polyurethanes; polyureas; and the like.

The thermoset may also be derived from an ionizing radiation-curable composition comprising a suitable mixture of prepolymers, oligomers and/or monomers having a polymerizable unsaturated bond(s) or an epoxy group(s) in the molecule thereof. Prepolymers and oligomers include: unsaturated polyesters, such as condensates of unsaturated dicarboxylic acids with polyhydric alcohols; methacrylates, such as polyester methacrylates, polyether methacrylates, polyol methacrylates, and melamine methacrylates; acrylates, such as polyester acrylates, epoxy acrylates, urethane acrylates, polyether acrylates, polyol acrylates, and melamine acrylates; and cationically polymerizable epoxy compounds. Urethane acrylates include, for example, polyether urethane (meth)acrylates represented by the following general formula which are prepared, for example, by reacting polyether diol with a hydroxyl-containing (meth)acrylate and a diisocyanate:

CH₂═C(R¹)—C(═O)OCH₂CH₂—OCONH—X—NHCOO—[—CH(R²)—(CH₂)ₙ)—O—]ₘ—CONH—X—NHC(═O)O—CH₂CH₂C(═O)OC(R¹)═CH₂

wherein R¹ and R² each independently represent a hydrogen atom or a methyl group; X represents a diisocyanate residue; n is an integer of 1 to 3; and m is an integer of 6 to 60. Diisocyanates usable as the polyether urethane (meth)acrylate include, for example, isophorone diisocyanate, dicyclohexylmethane diisocyanate, hexamethylene diisocyanate, diphenylmethane diisocyanate, and tolylene diisocyanate. Polyether diols include polyoxypropylene glycol, polyoxyethylene glycol, and polyoxytetramethylene glycol, these polyether diols having a number average molecular weight of 500 to 3,000 g/mol. Monomers usable for the formation of the ionizing radiation-curable resin include styrene monomers, such as styrene and α-methylstyrene, acrylic esters, such as methyl acrylate, 2-ethylhexyl acrylate, methoxyethyl acrylate, butoxyethyl acrylate, butyl acrylate, methoxybutyl acrylate, and phenyl acrylate, methacrylic esters, such as methyl methacrylate, ethyl methacrylate, propyl methacrylate, methoxyethyl methacrylate, ethoxymethyl methacrylate, phenyl methacrylate, and lauryl methacrylate, substituted amino alcohol esters of unsaturated substituted acids, such as 2-(N,N-diethylamino)ethyl acrylate, 2-(N,N-dimethylamino)ethyl methacrylate, 2-(N,N-dibenzylamino)methyl acrylate, and 2-(N,N-diethylamino)propyl acrylate, unsaturated carboxylic acid amides, such as acrylamide and methacrylamide, compounds, such as ethylene glycol diacrylate, propylene glycol diacrylate, neopentyl glycol diacrylate, 1,6-hexanediol diacrylate, and triethylene glycol diacrylate, polyfunctional compounds, such as dipropylene glycol diacrylate, ethylene glycol diacrylate, propylene glycol dimethacrylate, and diethylene glycol dimethacrylate, and/or polythiol compounds having two or more thiol groups in a branch thereof, for example, trimethylolpropane trithioglycolate, trimethylolpropane trithiopropylate, and pentaerythritol tetrathioglycol. A photopolymerization initiator may be added to the ionizing radiation-curable composition along with other additives (such a pigments, stabilizers, etc.). Photopolymerization initiators include acetophenones, benzophenones, Michler's benzoyl benzoate, α-aminoxime ester, tetramethylthiuram monosulfide, thioxanthenes, aromatic diazonium salt, aromatic sulfonium salt, and metallocene, n-Butylamine, triethylamine, tri-n-butylphosphine or the like may be further added as a photopolymerization accelerator (a sensitizer). The amount of the photopolymerization initiator added is preferably 1 to 10% by weight from the viewpoint of good curability. The photopolymerization initiator is preferably a benzophenone photopolymerization initiator from the viewpoint of good curability.

The ionizing radiation-curable composition may be cured to form the conformable substrate layer. The term “ionizing radiation” used herein refers to electromagnetic radiations or charged particle beams which have sufficient energy capable of polymerizing or crosslinking molecules, and generally refers to, for example, ultraviolet light or electron beam.

Exemplary thermoplastics include thermoplastic polymers such as those common to injection molding, rotational molding, blow molding, or structural foam molding such as acrylonitrile butadiene styrene (ABS); polycarbonate (PC) and polycarbonate blends such as PC/ABS, PC/PMMA (poly methyl methacrylate), PC/PET (polyethylene terephthalate), PC/PBT (polybutylene terephthalate), PC/SAN/SEBS (polycarbonate/poly (styrene-co-acrylonitrile))/(styrene-ethylene-butylene-styrene block copolymer), and co-siloxane grafted; polyolefins such as polyethylene including low density (LDPE), high density (HDPE), linear low density (LLDPE) and ultra-high molecular weight (UHMWPE) polyethylenes, and polypropylene (PP), polymethylpentene, polyisobutylene (PIB), ethylene propylene rubber (EPR), ethylene propylene diene monomer rubber (EPDM) and polybutene; polyamides such as Nylon 6, Nylon 4-6, Nylon 6-6, Nylon 11, Nylon 12, polyphthalamides (PPA), aramides, polyamide-imides (PAI); aliphatic polyesters such as polyglycolic acid, polylactic acid (PLA), polycaprolactone (PCL), polyhydroxyalkanoate, polyhydroxybutyrate, copolymer polyethylene adipate, polybutylene succinate, poly(3-hydroxybutyrate-co-3-hydroxyvalerate); aromatic polyesters such as polybutylene terephthalate (PBT), polyethylene terephthalate (PET), glycol-modified polyethylene terephthalate (PETG), polytrimethylene terephthalate, polyethylene naphthalate (PEN); polystyrene (PS); polymethylmethacrylate (PMMA); styrene-acrylonitrile (SAN); polyvinylidene chloride; polyvinyl butyral (PVB); cellulose acetate butyrate (CAB); cellulose acetate propionate (CAP); thermoplastic elastomers such as styrenic block copolymers, thermoplastic olefins, thermoplastic polyurethanes (TPU), thermoplastic copolyester and thermoplastic polyamides; acrylics and acrylic blends; polyetheretherketone (PEEK); polyetherketone (PEK); polyaryletherketone (PAEK); polyimides; polyoxymethylene (POM); polyacetal; polyphenylene sulfide (PPS); polyphenylene oxide (PPO); polysulfone; polytetrafluoroethylene (PTFE); polybenzimidazole; polyether sulfone (PES); polyetherimide (PEI); polyvinyl chloride (PVC); polyethylenimine (PEI); and blends thereof.

In one embodiment of the present disclosure, the conformable substrate layer of the present disclosure comprises at least one fluorine-containing polymer. Fluorine-containing polymers useful in the conformable substrate include, for example, fluoroolefins and fluorourethanes. Fluoroolefins include elastomeric fluoroolefin polymers, and thermoplastic fluoroolefin polymers. Any combination of these materials may also be used so long as they are miscible in one another. In some embodiments, fluorine-containing polymers useful in the present disclosure may also include other halogens, such as for, example chlorine. Fluorine-containing polymers may be derived from fluorinated monomers such as tetrafluoroethylene, hexafluoropropylene, vinylidene fluoride, vinyl fluoride, and chloro trifluoroethylene. Such fluorine-containing polymer containing conformable substrates may have improved stain resistance as compared to materials not comprising a fluorinated polymer. These fluorine-containing polymers can be thermoplastics (i.e. not chemically crosslinked) or thermosets (i.e. chemically crosslinked with multifunctional amines, multifunctional meth(acrylates), ionizing radiation and the like).

In one embodiment using a thermoset as the conformable substrate provides improved stain resistance, solvent resistance, high temperature mechanics, stiffness, creep resistance, etc. of the resulting finished article.

In addition to the polymers described above, the conformable substrate may comprise additives such as pigments or colorants such as metallic flakes, rheological modifiers, UV stabilizers, antioxidants, etc.

In one embodiment, the conformable substrate is a composite material, comprising a polymer and reinforcing material. The reinforcing material may be a fiber or particulate. Exemplary reinforcing materials include glass, carbon, aramid, polyethylene, polypropylene, quartz, or ceramic. The reinforcing material is embedded in a polymer matrix, benzoxazine resins; bis-maleimides; cyanate ester resins; epoxy resins; phenolic resins; unsaturated polyester resins; polyimides; isocyanate and polyisocyanate resins; polyisocyanurate resins amino resins, vinylester resins, and blends thereof.

The conformable substrate layer may be transparent, translucent, or opaque. It may be colored or colorless. The conformable substrate layer may, for example, be clear and colorless or pigmented with opaque, transparent, or translucent dyes and/or pigments.

The conformable substrate can have a variety of thicknesses, depending on the application. Exemplary thicknesses for the conformable substrate layer include: thicknesses of at least 5, 10, 20, 25, 50 or even 75 micrometers. In one embodiment, the substrate has a thickness of at most 25 mm or even 50 mm.

In one embodiment, the conformable substrate is much thicker (e.g., at least 5, 10 or even 20 times) than the average diameter of the plurality of microspheres. In another embodiment, the thickness of the conformable substrate layer is at least 50% of the average diameter of the plurality of microspheres, but less than 2, 3, 4, or even 5 times than the average diameter of the plurality of microspheres.

The conformable substrate is disposed onto the shaped transfer article, wherein the conformable substrate is in contact with the microsphere monolayer.

In one embodiment, the conformable substrate can be formed, for example, out of solution, aqueous dispersion, or 100% solids coating such as via hot melt, extrusion, or reactive coating. Use of solvent coating or aqueous dispersions can provide advantages such as lower processing temperatures which in turn permits the use of materials such as polyethylene in the transfer polymer layer. In addition, the use of certain higher boiling solvents may advantageously provide articles with reduced amounts of entrapped air in the solidified conformable substrate layer.

In another embodiment, the conformable substrate can be sprayed onto the first surface of the transfer article to create a thin conformable substrate layer such as that disclosed in FIG. 3, which shows a finished shaped article comprising a microsphere monolayer 32, wherein a plurality of microspheres is partially embedded in a conformable substrate 37, wherein the conformable substrate is in contact with a second substrate 38 opposite the microsphere monolayer.

In one embodiment, the conformable substrate can be formed from a film, which upon heating or pressure is conformed to the peaks and valleys of the first surface of the transfer article.

To ensure microsphere embedment in the conformable substrate, it is important to minimize air entrapment between the conformable substrate and the plurality of microspheres.

In the instance of a composite material as the conformable substrate, a prepreg may be used, wherein a co-molded film is laminated to several layers of carbon/epoxy prepreg and then cured in a compression mold along with the shaped transfer article under heat and pressure. Prepreg is a term for “pre-impregnated” composite fibers where a resin material or matrix material, such as epoxy is already present. The prepreg contains an amount of the resin material used to bond the fibers together and to bond to other components during manufacturing. The prepreg is normally heated to cure. Also, the prepreg may be stored at relatively low temperature to extend shelf life. The fibers for each layer of prepreg may be aligned in the same direction; that is, the fibers of each layer may be unidirectional. In other embodiments, the fibers for each layer of prepreg may be positioned in various directions or woven together. Further, the fibers for the prepreg may be substantially continuous or discontinuous. It will be appreciated by those skilled in the art that the fibers may be substantially any type of material that provides reinforcing strength to a matrix resin such as epoxy. It should be noted that, although epoxy is discussed as being the base layer for the composite, in some embodiments a resin other than epoxy may be used. For example, benzoxazine resins; bis-maleimides; cyanate ester resins; phenolic resins; unsaturated polyester resins; polyimides; isocyanate and polyisocyanate resins; polyisocyanurate resins, amino resins, or vinylester resins may be used as well.

During molding with the conformable substrate, the shaped transfer article may itself be the mold and the conformable substrate applied directly to the mold. In another embodiment, the shaped transfer article may be placed in a 2-part matched metal mold, which has the same shape as the shaped transfer article and the conformable substrate is applied between the molds.

The shaped transfer article with the conformable substrate thereon is then treated with heat, and/or pressure to embed the plurality of microspheres from the first surface of the shaped transfer article to the conformable substrate, and optionally cure the conformable substrate.

After forming the shaped article, the transfer carrier (comprising the transfer polymer layer and the support layer) is removed, leaving a shaped finished good. The microspheres may be held within the conformable substrate due to chemical and/or mechanical forces. In one embodiment, the conformable substrate comprises reactive chemistry which chemically interact with the microspheres. For example, silane-containing polymers can be used to react with untreated glass microspheres; epoxy-containing polymers can be used to react with amino treated glass microspheres; amine, acid, and/or anhydride-containing polymers can be used to react with epoxy-treated glass microspheres; radiation curable polymers can be used to react with (meth)acrylate-treated glass microspheres; and active hydrogen containing polymers, such as those comprising an alcohol, amine, carboxylic acid, etc. can be used to react with isocyanate-treated glass microspheres. Alternatively, or additionally, the microspheres are embedded in the conformable substrate more than 50% of their diameter which causes the microspheres to be mechanically held in place by the conformable substrate.

As mentioned above, the transfer polymer layer should release the plurality of microspheres, while the conformable substrate layer retains the plurality of microspheres. Generally, the transfer polymer layer and the conformable substrate layer are not the same material. The conformable substrate material should be selected based on the desired end use (for example, conductive properties, transparency or lack thereof, flexibility, etc.). The transfer polymer layer, on the other hand, should be selected such that it is releasable from not only the microsphere monolayer, but also the conformable substrate layer. The transfer polymer layer should also sufficiently hold the microsphere monolayer in position during the shaping step and the exposure of the conformable substrate. For example, a low-density polyethylene transfer polymer layer provides suitable properties when the conformable substrate is a polyurethane or epoxy resin. Additionally, a polyvinyl alcohol transfer polymer layer provides suitable properties when the conformable substrate is polypropylene. In one embodiment, the transfer polymer is a polyvinyl acetate, while the conformable substrate is a poly(meth)acylate. In one embodiment, the transfer polymer is a polypropylene, while the conformable substrate is an epoxy.

The shaped finished articles of the present disclosure comprise a plurality of microspheres, which are arranged in a monolayer (i.e., a single layer) on the surface of the conformable substrate. Typically, the plurality of microspheres are randomly-distributed and closely packed (i.e., generally there is not enough space between neighboring microspheres to place another microsphere). In one embodiment, the plurality of microspheres covers at least 65% and at most 80% of the first surface of the conformable substrate.

In one embodiment, the plurality of microspheres is patterned on the surface of the shaped transfer article and thus, patterned on the resulting shaped finished article. WO Publ. No. 2017/106239 (Clark et al.), incorporated herein by reference, discloses a monolayer of microspheres arranged in a microscopic periodic pattern, meaning that the microspheres are arranged in a pattern on the microscopic level (i.e., a pattern in relation to the other microspheres) and the pattern is periodic (i.e., not random and having an order to it). The unit repeat, i.e., the area consuming the repeat pattern may have a triangular, quadrilateral (e.g., squares, rhombus, rectangle, parallelogram), hexagonal, or other repeat pattern shape, which may be symmetric or asymmetric in nature. Appl. No. PCT/US2017/024711 (Walker et al.) incorporated herein by reference, discloses a monolayer of randomly distributed microspheres arranged in a predetermined pattern atop a surface. The predetermined pattern comprises at least one of (i) a plurality of the first areas, (ii) a plurality of the second areas, and (iii) combinations thereof. In one embodiment, the plurality of microspheres within the second area are closely packed. Exemplary shapes of the first and second areas include lines (or stripes), triangular, hexagonal, rectangular, or oblong shapes. The patterns may be pseudo-random, meaning that pattern may appear random but it is not. Pseudo-random patterns are typically less noticeable to the naked eye than a regular pattern.

In one embodiment, the surface of the finished article can be abraded to truncate the exposed top surfaces of the plurality of microspheres in the microsphere monolayer, allowing reduced haze and/or improved clarity. Such a technique is described in appl. No. PCT/US2017/045209 (Clark et al.), herein incorporated by reference.

In one embodiment, the shaped article may be further treated. For example, in one embodiment, the conformable substrate is a highly-crosslinked material, which initially is not crosslinked or is very lightly cross-linked, which is (further) cured (e.g., post cured) to generate a resin having a high crosslink density. Such further curing can include treatment by ultraviolet or e-beam to provide crosslinking of the conformable substrate layer. Such crosslinking may improve the resistance of the conformable substrate layer to organic solvents. Such radiation treatment may be done to either, or both, major surfaces of the conformable substrate layer. In addition, it may or may not be done through intervening layers.

### Additional Layers

In addition to the conformable substrate layer and microsphere monolayer, the resulting article of the present disclosure may also comprise additional layers to impart desirable characteristics into the article.

For example, a second substrate may be applied onto the conformable substrate opposite the microsphere monolayer. The second substrate can be a variety of materials including, for example, an adhesive, a metal, a composite, a thermoset or a thermoplastic.

In one embodiment, this second substrate is a reinforcing layer which can be used to provide advantageous handling characteristics, and in doing so, permit the use of a thinner conformable substrate layer. Examples of suitable reinforcing layers include polyurethanes resin systems, acrylic resin, polyester resins, and epoxy resins. Suitable polyurethane resin systems include, but are not limited to, those selected from at least one of: polyurethane dispersions, 2 part urethanes coated from solvent, and 100% solids 2 part urethanes. Suitable acrylic resin systems include, but are not limited to, those selected from UV-curable acrylic resin systems and thermally curable acrylic resin systems. Such systems may be solvent coated, aqueous dispersions, or hot melt coated. One suitable type of polyester resin is co-amorphous polyester resins. Suitable epoxy resin systems include, but are not limited to, those selected from at least one of two part and one part epoxy resins.

In one embodiment, the conformable substrate layer can optionally perform the function of acting as the adhesive for a desired second substrate and/or further comprise pigment(s) such that it also has a graphic function.

In one embodiment, the first major surface of the finished article of the present disclosure (depicted as surface 34 in FIG. 3) is durable, meaning that it has abrasion and/or scratch resistance. The scratch resistance can be measured by pencil hardness. In other words, at which hardness the pencil scratches the surface. In one embodiment, the finished articles of the present disclosure have a pencil hardness value of at least 6 H, 8 H, or even 10 H at a force of 2.5 Newtons. In one embodiment, the finished articles of the present disclosure have a pencil hardness value of at least 3 H, 5 H, 6 H, 8 H, 9 H, or even 10 H at a force of 7.5 Newtons.

The articles of the present disclosure have a coefficient of friction of less than 0.3 or even 0.2. The coefficient of friction can be measured, for example, following ASTM D1894 2014 “Standard Test Method for Static and Kinetic Coefficients of Friction of Plastic Film and Sheeting”. For example, a table top peel tester (such as Model 3M90, available from Instrumentors Inc., Strongsville, Ohio) can be used in the coefficient of friction mode to pull a test article across the glass surface at a rate of about 2.29 meters/minute (90 inches/minute) for at least about 5 seconds, wherein the surface comprising the plurality of microspheres contacts the glass surface. The transducer can be calibrated with the force from the weight of the steel substrate with foam as 1.00. In this way pulling forces can be directly read out as coefficient of friction (COF). The dynamic (kinetic) coefficient of friction can be determined by evaluating the graph of the COF values beginning one second after the start of the measurement.

In one embodiment, the finished article of the present disclosure exhibits a desirable tactile experience. Although not wanting to be limited by theory, it is believed that height differences between the exposed microspheres may play a role in how smooth or pleasurable the surface is perceived by a person interacting with the surfaces. In one embodiment, the height of the exposed microspheres can be measured using profilometry and compared across the sample surface. In one embodiment, the difference in the apexes of the plurality of microspheres deviates from the average by no more than 5, 4, 2, or even 1 micrometers, with the smaller the deviation the more desirable the tactile experience. A more intensive analysis of profilometry data can be performed to profile the surface. In one embodiment, the surface of the finished article of the present disclosure when tested per the Surface Profilometry Measurement described below, has an Rq Envelope of less than 3, 2 or even 1 micrometers and an Rp Envelope of less than 6, 5, or even 4 micrometers.

In one embodiment, the finished article of the present disclosure exhibits a stain resistance to yellow mustard at elevated temperature and humidity as measured by the change in b* of less than 50. The products to which the articles of the present disclosure may be applied are often exposed to elevated temperatures and humidity. While many materials may provide adequate stain resistance at ambient conditions they often fail to provide sufficient stain resistance when exposed to more demanding environments for prolonged times, such as at 66° C. (150° F.) and 85% relative humidity for 24 hours and 72 hours; 60° C. and 90% relative humidity for 24 hours; or 65° C. and 80% relative humidity for 72 hours.

In one embodiment, the finished articles of the present disclosure are not retroreflective. Retroreflectivity of an article can be expressed in terms of its coefficient of retroreflectivity (Ra)

Rₐ=Eᵣ*d²/Eₛ*A

where:
Eᵣ=illumination incident upon the receiver
Eₛ=illumination incident upon a plane perpendicular to the incident ray of the specimen position, measured in the same units as Eᵣ
d=distance from the specimen to the projector
A=area of the test surface
   The coefficient of retroreflectivity (Rₐ) is further described in U.S. Pat. No. 3,700,305 (Bingham). In one embodiment, the articles of the present disclosure have a coefficient of retroreflection of less than or equal to 10, 5, 1, 0.5, or even 0.3 candelas/lux/square meter measured at 0.2° observation angle and 5° entrance angle following ASTM E810-03 (2013) “Standard Test Method for Coefficient of Retroreflection of Retroreflective Sheeting Utilizing the Coplanar Geometry”.

Advantageously, the article of the present disclosure is shaped and comprise a monolayer of microspheres partially embedded in a conformable substrate. Such articles can be used on article such as a clothing article or footwear; automobile, marine, or other vehicle seat coverings; automobile, marine, or other vehicle bodies; orthopedic devices; electronic devices (including, for example, track pads, and outer surface cover), hand held devices, household appliances; sporting goods; and the like.

Surface Roughness can be determined as follows:

### Surface Profilometry Measurement

Roughness parameters used to describe a textured surface can be determined by making measurements of the entire surface topography using the following steps.

### 1. Collection of Surface Topography

Topographic measurements may be made using a Stylus Profilometer, Dektak 8 (Veeco Instruments Incorporated, Tucson, Ariz.) using a 2.5 micrometer radius tip and 2 milligrams of force. The topographical maps generated may be composed of 361 line scans spread equally over 2 millimeters in the y-scan direction. Each line may be 2 millimeters long in the x-scan direction and include, for example, 6000 data points. Samples may be at least 1 centimeter square, without rough edges and mounted on microscopy slides, with double-sided permanent adhesive tape.

### 2. Initial Processing of Surface Topography

An x-average filter may be applied to the profilometry data collected in step 1 to remove small variations in the z-position between sequential scan lines. Then a tilt-removal operation may be performed to level the topographic map, and the processed map saved.

### 3. Determination of Top Surface Envelope

The data from step 2 may be analyzed using the following routines in MATLAB software (MathWorks, Incorporated, Natick, Mass.).

a. Rescale Data

A bicubic interpolation method, imresize.m may be applied to the maps to provide equal aspect ratio data points.

b. Subdivided Topographic Map

The 2 millimeter×2 millimeter map may be divided into four 1 millimeter×1 millimeter submaps for further analysis.

c. Calculate Surface Curvature Map

A surface curvature map may be generated as follows.

1. The curvature can be measured within approximately 10 micrometers on either side of each pixel.

2. After the curvature for a pixel is calculated, two conditions can be applied: a) was the curvature less than −0.002 l/micrometers (meaning the curvature is downwards (i.e., concave), and the absolute radius of curvature less than 500 micrometers), and b) was the pixel above the mean plane of the surface topography. Satisfying these two conditions can indicate that the pixel was near the top of a feature and thus exposed to contact by a user. This measurement can be performed in both the x- and y-directions, and the combined map of the two curvature maps determined (where each pixel satisfies the height condition, and the curvature condition in each direction).

3. Image processing may be performed first using median filtering, with a 3 pixels by 3 pixels window, followed by a morphological open (disk radius=1 pixel) and then a morphological close (line length of 3 pixels, oriented in the y-direction) to remove artifacts.

4. The individual features identified can then be further analyzed according to steps 5-7 below.

d. Calculate the Top Surface Envelope

For each image feature found in the previous step, the position (in x, y and z) of the highest point may be found by performing a search of the topography data within the binary mask. This array of points can then be used to define the top surface envelope. The top surface envelope may be visualized by creating a regular mesh describing the surface from the array of data points, using the MATLAB routine TriScatteredInterp.m. which corresponds to the textured surface.

### 4. Analysis of Top Surface Envelope

Conventional roughness parameters may be used to analyze the envelope surface as described in Table 1.

TABLE 1

| Parameter | Definition | Notes |
|---|---|---|
| Envelope Rq | ${R}_{q} = \sqrt{\frac{{\sum }_{i = 1}^{n} {( {Z}_{i} - \overline{Z} )}^{2}}{n}}$ | The RMS roughness, or the standard deviation of the height values of the surface envelope defined by the tops of the protrusions/microspheres. |
| Envelope | Rp = max(Z) − | Maximum Peak Height. The height |
| Rp | mean(Z) | difference between the mean of the |
| | | surface defined by the tops of all the |
| | | protrusions and the top of the highest |
| | | protrusion in the evaluation region |
| | | (here a 1 millimeter × 1 millimeter |
| | | evaluation area). |

### 5. Analysis of Individual Features

The characteristics of individual features can then be determined. First, the radius of curvature of each feature may be calculated from the topographic map. The method involves finding the curvature of the feature at its highest point, as this location may be most exposed to a user's fingertip. The curvature may be calculated at the highest point on the feature as well as the 8 nearest neighbor pixels. For irregular features, the highest point of the feature sometimes may be at the edge of the feature, and so some of the nearest neighbor pixels are not on the feature. To accommodate this, only the pixels located on the feature are included. The mean of the curvature of all valid pixels at and near the highest point can be reported as the curvature, and the reciprocal of the mean local curvature can be reported as the radius of curvature for that feature. Negative numbers indicate that the features curve downwards. As the radius of curvature (RoC) approaches zero, the sharper the feature is. The parameters Rt and Sm (defined in Table 2) can be computed using x-stylus analyses performed in Vision Software (Veeco Incorporated, Tucson, Ariz.) where every line in the map is analyzed and the mean value is reported. In each case, each line can be subdivided into 5 sublengths and analyzed.

TABLE 2

| Parameter | Notes |
|---|---|
| RoC | Radius of curvature of the sharpest feature in the evaluation |
| sharp | region (here a 1 millimeter × 1 millimeter evaluation area). |
| | The smaller the radius of curvature, the sharper the feature. |
| | This reports the sharpest feature in the evaluation area. |
| Rt | Peak to valley difference calculated over an evaluation length. |
| | Each scan line (in the x-direction) in the map is sub-divided |
| | into 5 evaluation lengths and the values are averaged for each |
| | line and then averaged for all lines. |
| Sm | Mean peak spacing: mean spacing between profile peaks at |
| | the mean line, measured over the evaluation length. A profile |
| | peak is the highest point on the profile between an upwards |
| | and downwards crossing of the profile of the mean line. |

### 6. Analysis of Feature Spacing

Feature spacing may be determined by counting the number of features/square millimeter area as determined in step 5.

### 7. Analysis of Irregular Features

Irregular features can be measured using MATLAB software. First, the area of the image feature (defined as the portion of a protrusion with height within 5 micrometers of the peak of the protrusion) may be measured using the MATLAB routine regionprops.m. Then, the perimeter of the image feature may be measured. The metric of regularity can be defined as the ratio of the image feature area to the area calculated for a hemisphere of the same perimeter (for an ellipsoid, the major and minor axes lengths obtained with regionprops.m were used). The metric of regularity may be defined as being 1 for a perfectly regular ellipsoid. A metric below 0.85 or above 1.15 is indicative of an irregular shaped feature. The image features which are touching the edges of the measured area may be ignored since they represent incomplete features. The number fraction of irregular features can be defined as the ratio of the number of irregular shaped protrusions to the total number of protrusions in the sampling area. The area fraction of irregular features can be defined as the ratio of the total area of irregular shaped protrusions to the total area of all protrusions in the sampling area. The total sampling area may be 1 millimeter×1 millimeter.

Exemplary embodiments of the present disclosure include, but are not limited to, the following:

Embodiment 1. A shaped transfer article comprising:
a microsphere monolayer comprising a plurality of microspheres;
a transfer polymer layer comprising a first major surface and an opposing second major surface; and
a support layer,
   wherein the plurality of microspheres are partially embedded in the first major surface of the transfer polymer layer; and the support layer is disposed on the second major surface of the transfer polymer layer, and wherein the shaped transfer article is non-planar.

Embodiment 2. The shaped transfer article of embodiment 1, wherein the transfer polymer layer comprises polyethylene, polypropylene, organic waxes, polyethylene oxide, polyvinyl alcohol, ethylene vinyl acetate, polyvinyl acetate, and blends thereof.

Embodiment 3. The shaped transfer article of any one of the previous embodiments, wherein the transfer polymer layer has a thickness of at least 5 micrometers and at most 75 micrometers.

Embodiment 4. The shaped transfer article of any one of the previous embodiments, wherein the plurality of microspheres have an average diameter of 5 to 200 micrometers.

Embodiment 5. The shaped transfer article of any one of the previous embodiments, wherein the plurality of microspheres have an average sphericity of at least 80%.

Embodiment 6. The shaped transfer article of any one of the previous embodiments, wherein the plurality of microspheres have an average size difference of no more than 40%.

Embodiment 7. The transfer article of any one of the previous embodiments, wherein the plurality of microspheres are transparent.

Embodiment 8. The transfer article of any one of embodiments 1-6, wherein the plurality of microspheres are opaque.

Embodiment 9. The transfer article of any one of the previous embodiments, wherein the microsphere monolayer is not chemically adhered to the transfer polymer layer.

Embodiment 10. The transfer article of any one of the previous embodiments, wherein the plurality of microspheres are in a microscopic periodic pattern and the plurality of microspheres covers less than 50% of the first major surface of the transfer polymer layer.

Embodiment 11. The transfer article of any one of embodiments 1-9, wherein the microsphere monolayer comprises a first area substantially free of microspheres and a second area comprising a plurality of randomly-distributed microspheres, wherein the microsphere monolayer comprises a predetermined pattern, the predetermined pattern comprises at least one of (i) a plurality of the first areas, (ii) a plurality of the second areas, and (iii) combinations thereof.

Embodiment 12. The transfer article of embodiment 11, wherein the plurality of microspheres within the second area are closely packed.

Embodiment 13. The transfer article of any one of the previous embodiments, wherein the plurality of microspheres a comprise a plastic or a metal.

Embodiment 14. The transfer article of any one of the previous embodiments, wherein the plurality of microspheres a comprise alumina.

Embodiment 15. A method of making a shaped article comprising:
obtaining the shaped transfer article of any one of the previous embodiments; and contacting the monolayer of microspheres with a conformable substrate.

Embodiment 16. The method of embodiment 15, wherein the shaped transfer article is made by shaping the transfer article of any one of embodiments 1-14.

Embodiment 17. The method of embodiment 15, wherein the shaped transfer article is made by first shaping the transfer polymer layer then contacting the shaped transfer polymer layer with the plurality of microspheres.

Embodiment 18. The method of any one of embodiments 16-17, wherein the shaping comprises exposure to temperature, pressure, or a combination thereof.

19. The method of any one of embodiments 15-18, wherein the conformable substrate comprises at least one of an epoxy, an acrylic, a crosslinked urethane, unsaturated polyester, bismaleimide, and combinations thereof.

Embodiment 20. The method of any one of embodiments 15-19, wherein the conformable substrate is a composite.

Embodiment 21. The method of any one of embodiments 15-20, wherein the conformable substrate is a thermoset.

Embodiment 22. The method of any one of embodiments 15-21, further comprising disposing a second substrate onto the conformable substrate layer opposite the monolayer of microspheres.

Embodiment 23. The method of any one of embodiments 15-22, further comprising removing the transfer polymer layer to form a shaped article wherein the plurality of microspheres is partially embedded in the conformable substrate layer.

Embodiment 24. The method of embodiment 23, further comprising abrading the monolayer of microspheres to truncate the plurality of microspheres.

Embodiment 25. A finished shaped article comprising:
a monolayer of microspheres comprising a plurality of microspheres, wherein the plurality of microspheres is partially embedded in a composite, wherein the finished article is non-planar, and wherein the difference in the apexes of the plurality of microspheres deviates from the average by no more than 5 microns.

Embodiment 26. A finished shaped article comprising:
a monolayer of microspheres comprising a plurality of microspheres, wherein the plurality of microspheres is partially embedded in an epoxy, wherein the finished article is non-planar, and wherein the difference in the apexes of the plurality of microspheres deviates from the average by no more than 5 microns.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; St. Lois, Mo., or known to those skilled in the art unless otherwise stated or apparent.

These abbreviations are used in the following examples: cc=cubic centimeter, cm=centimeter, mm=millimeter, N=newton, ppm=parts per million, s=seconds, and psi=pressure per square inch.

Materials

| Designation | Description |
|---|---|
| DP100 | A two-part epoxy adhesive offering fast cure and |
| | machinability, available under the trade designation 3M |
| | SCOTCH-WELD EPOXY ADHESIVE DP100 from 3M |
| | Company, Maplewood, MN. |
| DP105 | A two-part epoxy adhesive offering fast setting, very |
| | flexible 1:1 mix ratio epoxy adhesive/sealant available |
| | under the trade designation 3M SCOTCH-WELD |
| | EPOXY ADHESIVE DP 105 from 3M Company, |
| | Maplewood, MN. |
| A1100 | gamma-Aminopropyltrimethoxysilane, a clear liquid |
| | coupling agent available under the trade designation |
| | SILQUEST A1100 from Momentive Performance |
| | Materials Incorporated, Columbus, OH. |
| BOROSILICATE GLASS | Milled borosilicate glass powder having a size distribution |
| POWDER | of less than 200 mesh and density of 2.23 grams/cubic |
| | centimeters, and a refractive index of 1.476, available |
| | under the trade designation PYREX 7740 from Strategic |
| | Materials Incorporated, Houston TX. |
| LDPE | Low density polyethylene available under the trade |
| | designation PETROTHENE NA219-000 from |
| | LyondellBasell, Houston, TX. |

### Test Methods

### Pencil Hardness

Parts were evaluated for pencil hardness according to ASTM D3363-05 (2011)e2. Abrasive sandpaper (Grit No. 400) was adhered to a flat and smooth benchtop with double coated tape. Pencil leads (Turquoise Premium pencil leads (10 H to 6 B in hardness) from Prismacolor Professional Art Supplies, a subsidiary of Newell Rubbermaid Office Products, Oak Brook, Ill. were used. The pencil leads in a mechanical lead holder (Totiens 210 99 from Cretacolor, Hirm, Austria) were held at an angle of 90° to the abrasive paper and abraded until a flat, smooth, circular cross-section was achieved, free of chips or nicks on the edge of the lead. The force on the tip of the pencil was fixed at 7.5 N or in some cases less. Using a freshly prepared pencil lead for each test, the lead was pressed firmly against the part at a 45° angle and at the desired load using an Elcometer 3086 Motorised Pencil Hardness Tester (Elcometer Incorporated, Rochester Hills, Mich.) and drawn across the test panel in the “forward” direction for a distance of at least ¼ inch (6.4 mm). Three pencil tracks were made for each grade of lead hardness. Prior to inspection, crumbled lead was removed from the test area using a damp paper towel wetted with isopropyl alcohol. The test panel was inspected by eye for defects and under an optical microscope (50×-1000× magnification) for the first ⅛ to ¼ inch (3.2 to 6.4 mm) of each pencil track. Moving from harder leads to softer, the process was repeated down the hardness scale until a pencil was found that did not scratch the film or rupture it, or dislodge or partially dislodge any microspheres. At least two of three tracks at each lead hardness were required to meet these criteria to pass. The hardest level of lead that passed was reported as the pencil hardness of the test panel. Values of 3 H at a force of 5 Newtons, or harder, are desirable.

### Erichsen Scratch Test

An Erichsen Scratch Tester (model 318, available from Erichsen GmbH & Co. KG in Hemer Germany) was used. A 0.75 mm tungsten-carbide rounded tip pencil was used to scratch the surface of interest while moving across the surface at varying levels of force by pushing a calibrated spring to provide an increasing challenge to the surface. Starting at 1 Newton force and increasing in increments of 1 Newton force, the surface is repeatedly challenged with more forceful tests. After each test, the surface was inspected by eye to determine if a scratch can be detected. When a scratch can be barely detected then that Newton force was reported.

### Example 1: Making Shaped Bead Film Transfer Article

Borosilicate glass powder was passed through a flame treater twice by passing it through a hydrogen/oxygen flame at a rate of 3 grams/minute to form microspheres that were collected in a stainless steel container whereupon metallic impurities were removed using a magnet. The resulting glass microspheres were treated with 600 ppm of A1100 in the following manner. The silane was dissolved in water, then added to the microspheres with mixing, air dried overnight, followed by drying at 110° C. for 20 minutes. The dried, silane treated microspheres were then sieved to remove any agglomerates and provide microspheres having a size of 75 micrometers or less and were free flowing. The resulting transparent silane treated microspheres were cascade coated using a mechanical sifter onto a transfer carrier comprising a 25 micrometer (0.0010 inch) low density polyethylene coating on a 97 micrometer (0.0038 inch) polyester substrate liner which had been preheated to about 140° C. (284° F.), to form a bead carrier having a uniform layer of transparent microspheres embedded in the low density polyethylene layer to a depth corresponding to about 30-40% of their diameter as determined by a magnifying imaging system.

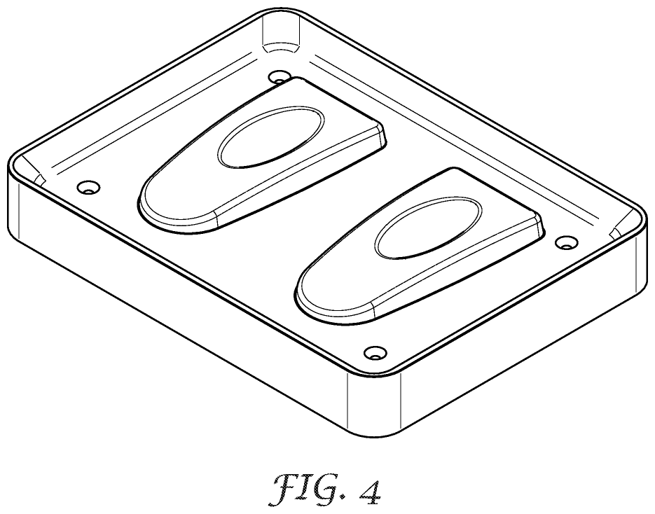

A male test mold having a complex shape with various radii and draft angles was used to form a shaped transfer film. The male test mold used is shown in FIG. 4 (drawn to scale), which comprises two tapered popsicle-like shapes having an indented oval feature in the middle of each shape. The tapered popsicle-like shape had a width across the middle of approximately 5 cm, a length across the central axis of approximately 11 cm and a height in the middle of the shape of approximately 1 cm. A sample of the bead film transfer article measuring 20.3×30.5 centimeters (8×12 inches) was placed into the male test mold such that the exposed microspheres were facing the surface of the male test mold. The transfer article was then thermoformed using a Hy⋅Tech Accuform IL50 (Hy⋅Tech Forming Systems (USA), Inc., Phoenix, Ariz.). The parameters used for shaping the bead film transfer article are shown in Table 3 below. After shaping, the shaped transfer article was removed from the mold. The shaped transfer article then becomes a negative or hollow cavity for making a shaped finished good. The surface of the hollow cavity comprises the monolayer of partially embedded microspheres.

TABLE 3

| Heated Platen | Mold Side | Preheat | Forming | Preheat | Forming | Exhaust |
|---|---|---|---|---|---|---|
| Temperature | Temperature | Time | Pressure | Pressure | Time | Time |
| (° F./° C.) | (° F./° C.) | (s) | (psi) | (psi) | (s) | (s) |
| 225/107 | 80/27 | 1 | 475 | 65 | 4 | 2 |

### Example 2: Making Shaped Finished Article

The cavity of the transfer article of Example 1 was then filled with DP100 delivered via the static mixer and dispenser as supplied. After curing for 16 hours at 23° C. (73° F.), the finished article comprising the cured epoxy having a surface comprising a monolayer of partially embedded microspheres was separated from the LDPE transfer layer and polyester substrate. The monolayer of microspheres was embedded at approximately 60-70% of their diameter on the surface of the shaped finished article.

### Example 3

A finished beaded article was prepared as in Example 2 except that DP105 was used in place of DP100.

### Example 4: Making Shaped Transfer Article

A transfer carrier measuring 20.3×30.5 centimeters (8×12 inches) comprising a LDPE coated polyester substrate liner was thermoformed using a Hy⋅Tech Accuform IL50. The thermoforming conditions used are shown in Table 4 below. The test mold was a five-sided box which was approximately 5 cm wide by approximately 10 cm long with a height on the sides of approximately 0.75 cm. The transfer carrier was placed such that the LDPE substrate faced the test mold. The thermoformed transfer carrier was removed from the mold. The shaped transfer carrier, comprising a cavity with a polyethylene surface was then heated to 105° C. (221° F.) and cascaded with borosilicate glass microspheres as described in Example 1 until a uniform coverage was obtained on the surface of the LDPE to form a shaped bead film transfer article.

TABLE 4

| Heated Platen | Mold Side | Preheat | Forming | Preheat | Forming | Exhaust |
|---|---|---|---|---|---|---|
| Temperature | Temperature | Time | Pressure | Pressure | Time | Time |
| (° F./° C.) | (° F./° C.) | (s) | (psi) | (psi) | (s) | (s) |
| 300/149 | 80/27 | 8 | 475 | 65 | 4 | 2 |

### Example 5: Making Shaped Finished Article

The shaped bead film transfer article from Example 4 was cooled and DP100 was added to the cavity and cured for 16 hours at 23° C. (73° F.). The finished article comprising the cured epoxy having a surface comprising a monolayer of partially embedded microspheres was separated from the LDPE transfer layer and polyester substrate. The monolayer of microspheres was embedded at approximately 60-70% of their diameter on the surface of the shaped finished article.

### Comparative Example 1

A part was made as described in Example 2 except no microspheres were present.

### Comparative Example 2

A part was made as described in Example 3 except no microspheres were present.

Shown in Table 5 are the results of Pencil Hardness and the Erichsen Scratch Test for various Examples, which were tested on planar portions of each example.

TABLE 5

| | Pencil | Erichsen |
|---|---|---|
| Example | Hardness | Scratch Test |
| 2 | 10 H | 4N |
| 3 | 10 H | 7N |
| 4* | <6B | Not measured |
| 5 | 10 H | 4N |
| CE1 | 2B | <1N |
| CE2 | 8B | <1N |

*Example 4 was not thermoformed prior to the Pencil Hardness Test

Foreseeable modifications and alterations of this invention will be apparent to those skilled in the art without departing from the scope and spirit of this invention. This invention should not be restricted to the embodiments that are set forth in this application for illustrative purposes. To the extent that there is a conflict or discrepancy between this specification and the disclosure in any document incorporated by reference herein, this specification will control.

1. A shaped transfer article comprising:
a microsphere monolayer comprising a plurality of microspheres;
a transfer polymer layer comprising a first major surface and an opposing second major surface; and
a support layer, wherein the support layer is non-planar,
wherein the plurality of microspheres are partially embedded in the first major surface of the transfer polymer layer; and the support layer is disposed on the second major surface of the transfer polymer layer.

2. The shaped transfer article of claim 1, wherein the transfer polymer layer comprises polyethylene, polypropylene, organic waxes, polyethylene oxide, polyvinyl alcohol, ethylene vinyl acetate, polyvinyl acetate, and blends thereof.

3. The shaped transfer article of claim 1, wherein the transfer polymer layer has a thickness of at least 5 micrometers and at most 75 micrometers.

4. The shaped transfer article of claim 1, wherein the microsphere monolayer is not chemically adhered to the transfer polymer layer.

5. The shaped transfer article of claim 1, wherein the plurality of microspheres are in a microscopic periodic pattern and the plurality of microspheres covers less than 50% of the first major surface of the transfer polymer layer.

6. The transfer article of claim 1, wherein the microsphere monolayer comprises a first area substantially free of microspheres and a second area comprising a plurality of randomly-distributed microspheres, wherein the microsphere monolayer comprises a predetermined pattern, the predetermined pattern comprises at least one of (i) a plurality of the first areas, (ii) a plurality of the second areas, and (iii) combinations thereof.

7. A method of making a shaped article comprising:
obtaining the shaped transfer article of claim 1; and contacting the monolayer of microspheres with a conformable substrate.

8. The method of claim 7, wherein the shaped transfer article is made by shaping the transfer article of claim 1.

9. The method of claim 7, wherein the shaped transfer article is made by first shaping the transfer polymer layer then contacting the shaped transfer polymer layer with the plurality of microspheres.

10. The method of claim 8, wherein the shaping comprises exposure to temperature, pressure, or a combination thereof.

11. The method of claim 7, wherein the conformable substrate is a composite.

12. The method of claim 7, wherein the conformable substrate is a thermoset.

13. The method of claim 7, further comprising removing the transfer polymer layer to form a shaped article wherein the plurality of microspheres is partially embedded in the conformable substrate layer.

14. A finished shaped article comprising:
a monolayer of microspheres comprising a plurality of microspheres, wherein the plurality of microspheres is partially embedded in a composite, wherein the finished article is non-planar, and wherein the difference in the apexes of the plurality of microspheres deviates from the average by no more than 5 microns.

15. A finished shaped article comprising:
a monolayer of microspheres comprising a plurality of microspheres, wherein the plurality of microspheres is partially embedded in an epoxy, wherein the finished article is non-planar, and wherein the difference in the apexes of the plurality of microspheres deviates from the average by no more than 5 microns.

16. The shaped transfer article of claim 1, wherein the plurality of microspheres have an average diameter of 5 to 200 micrometers.

17. The shaped transfer article of claim 1, wherein the plurality of microspheres have an average size difference of no more than 40%.

18. The transfer article of claim 6, wherein the plurality of microspheres within the second area are closely packed.

19. The transfer article of claim 1, wherein the plurality of microspheres a comprise alumina.

20. The transfer article of claim 1, wherein the plurality of microspheres are opaque.
